(19) United States
(12) Patent Application Publication
(10) Pub. No.: US 2015/0342812 A1
(43) Pub. Date: Dec. 3, 2015

(54) GRAVITY DISPENSING BIN SYSTEM

(71) Applicants: Duane Nedig, Calgary (CA); Shad Forsyth, Surrey (CA)

(72) Inventors: Duane Nedig, Calgary (CA); Shad Forsyth, Surrey (CA)

(73) Assignee: Associated Health Systems, Surrey (CA)

(21) Appl. No.: 14/291,300

(22) Filed: May 30, 2014

(51) Int. Cl. A61G 12/00

(52) U.S. Cl. CPC A61G 12/001

(57) ABSTRACT

A device for storing, transporting and dispensing medical items is provided, wherein the device comprises a multiplicity of compartments with an upper facing space and lower facing space.

### FIELD OF THE INVENTION

The present invention pertains to the field of dispensing apparatus, and more particularly, to bins that use gravity to move individually wrapped products from an upper end which is used for loading to a lower dispensing opening all for containing medical items or articles and, still more particularly the invention refers to a mobile device for containing, carrying, displaying and dispensing medical items including but not limited to individually wrapped pads, sutures, surgical instruments, and catheters.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

Gravity dispensing systems which use a bin containing a multiplicity of the product to be dispensed are well known. These systems have been used for dispensing bulk products in hardware, for bolts, nuts; in food, for dispensing bulk candy, cereals, or other consumables; as well as many other types of products. These bins generally comprise an enclosure having an optional upper opening for addition of product and a lower opening used to dispense the contents or allow access to the contents of the enclosure. As product is removed from the lower opening, the contents of the enclosure move downward through action of gravity upon the contents, making the contents available and accessible to the lower opening. For material capable of fluid movement within the enclosure and under standard storage conditions, downwardly converging walls are often used to constrict the flow of the contents towards the lower opening.

Non-reusable boxes are known in the art for dispensing sutures or other disposable and commonly sterilized medical items in a clinical treatment facility. These individually wrapped medical items are generally stocked in a storage room or facility outside of the treatment room or other area where the items are required. Upon need for the medical items, such as a planned procedure or medical emergency; medical personnel must travel to the storage room or facility, select the items anticipated to be used for the procedure or emergency. The time taken to select, or resupply, the medical items is an inconvenience and, in time critical situations, can be dangerous. Further, medical items, particularly those maintained in sterile condition, expire and therefore there is a need to maintain stock in a manner capable of maintaining a sequential order based upon expiry, serial number registration, or other order desired by medical personnel.

The art is therefore in need of a device capable of accommodating and organizing medical items for quick and easy access at the point of medical need, the device preferably capable of easy movement. As well the art is in need of a device that assists in the maintaining medical items ordering and facilitates use of medical items in a predetermined sequential order (“stock rotation”).

### SUMMARY OF THE INVENTION

It is therefore an object of the present invention to provide a device for carrying medical items, maintaining medical items in an established order, and constraining access to the medical items in other than a serial means, while also providing for easy and quick access to the medical items.

It is still another object of the present invention to provide a device for carrying medical items, wherein the device comprises a multiplicity of hollow compartments, each compartment enclosed on all but one facing surface, said facing surface comprising a facing plate conforming to the lateral edges of each compartment and describing an offset from both the upper edge and lower edge of the facing surface resulting in an facing surface upper space and a facing surface lower space.

It is still another object of the present invention to provide a device for carrying medical items, wherein the device comprises:

A multiplicity of hollow compartments
each compartment being a hollow cuboid described by an upper and lower planar surface, a left lateral surface, a right lateral surface, a rear planar surface and a facing planar surface;
   wherein said upper planar surface, lower planar surface, left lateral planar surface, right lateral planar surface and rear planar surface are contiguous;
   wherein said facing planar surface comprises:
      an upper edge offset and lower edge offset from the upper planar surface and lower planar surface, thereby providing an upper facing surface space and a lower facing surface space,
      a right lateral edge and a left lateral edge substantially contiguous with the facing edge of said left lateral planar surface and right lateral planar surfaces; and
   wherein said upper edge offset and lower edge offset are offset from said upper planar surface and lower planar surfaces by a distance of at least 27 mm.

In a further embodiment of the present invention, said rear planar surface is removable, providing access to the hollow interior described by the upper planar surface, lower planar surface, right lateral planar surface, left lateral planar surface and facing planar surface.

In another aspect of the present invention, said upper edge of said facing planar surface contains a semi-circular depression of radius at least 15 mm.

In another aspect of the present invention, said lower edge of said facing planar surface contains a semi-circular depression of radius at least 15 mm.

In a still further aspect of the present invention, said lower edge and upper edge of said facing planar surface contain a semi-circular depression of at least 15 mm.

In another embodiment the present invention provides for a device for carrying medical items, wherein the device comprises:

a multiplicity of hollow compartments
each compartment being a hollow cuboid described by an upper planar surface, a lower planar surface, a left lateral planar surface, a right lateral planar surface, a rear planar surface, and a facing planar surface
   wherein said upper planar surface, lower planar surface, left lateral planar surface, right lateral planar surface and rear planar surface are contiguous,
   wherein said facing planar surface comprises
      an upper edge offset and lower edge offset from the upper planar surface and lower planar surface, thereby providing an upper facing surface space and a lower facing surface space, and
      a right lateral edge and a left lateral edge substantially contiguous with the facing edge of said left lateral planar surface and right lateral planar surfaces,
      wherein said upper edge offset and lower edge offset are offset from said upper planar surface and lower planar surface a by a distance of at least 27 mm;
   wherein said rear planar surface comprises
      an upper edge and lower edge offset from the upper planar surface and lower planar surface, thereby providing an upper rear surface space and a lower rear surface space, and
      a right lateral edge and a left lateral edge substantially contiguous with the rear edge of said left lateral planar surface and right lateral planar surface; and
      wherein said upper edge offset and lower edge offset are offset from said upper planar surface and lower planar surfaces by a distance of at least 27 mm.

In another aspect of the present invention, said upper edge of said facing planar surface and upper edge of said rear planar surface contains a semi-circular depression of radius at least 15 mm.

In another aspect of the present invention, said lower edge of said facing planar surface and lower edge of said rear planar surface contains a semi-circular depression of radius at least 15 mm.

In a still further aspect of the present invention, said lower edge and upper edge of said facing planar surface and upper edge and lower edge of said rear planar surface contain a semi-circular depression of at least 15 mm.

It is still another object of the present invention to provide a device for carrying medical items, wherein the device comprises:

a multiplicity of hollow compartments
each compartment being a hollow cuboid described by an upper and lower planar surface, a left lateral surface, a right lateral surface, and a facing planar surface;
   wherein said upper planar surface, lower planar surface, left lateral planar surface, and right lateral planar surface are contiguous;
   wherein said facing planar surface comprises:
      an upper edge offset and lower edge offset from the upper planar surface and lower planar surface, thereby providing an upper facing surface space and a lower facing surface space,
      a right lateral edge and a left lateral edge substantially contiguous with the facing edge of said left lateral planar surface and right lateral planar surfaces; and
   wherein said upper edge offset and lower edge offset are offset from said upper planar surface and lower planar surfaces by a distance of at least 27 mm.

In another aspect of the present invention, said upper edge of said facing planar surface contains a semi-circular depression of radius at least 15 mm.

In another aspect of the present invention, said lower edge of said facing planar surface contains a semi-circular depression of radius at least 15 mm.

In a still further aspect of the present invention, said lower edge and upper edge of said facing planar surface contain a semi-circular depression of at least 15 mm.

### BRIEF DESCRIPTION OF THE FIGURES

FIG. 1. shows a forward, top perspective of the device according to a preferred embodiment of the invention;

FIG. 2. shows a side elevation cut-away view of one of the compartments that form the device of the present invention;

FIG. 3. shows a side elevation, partially cross-sectional view of a combination of compartments that form the device of the present invention, illustrating the ability to have different sizes of compartments for receiving and maintaining medical articles of different sizes; and

FIG. 4. shows a forward perspective of one embodiment of the device of the present invention.

### DETAILED DESCRIPTION OF THE PRESENT INVENTION

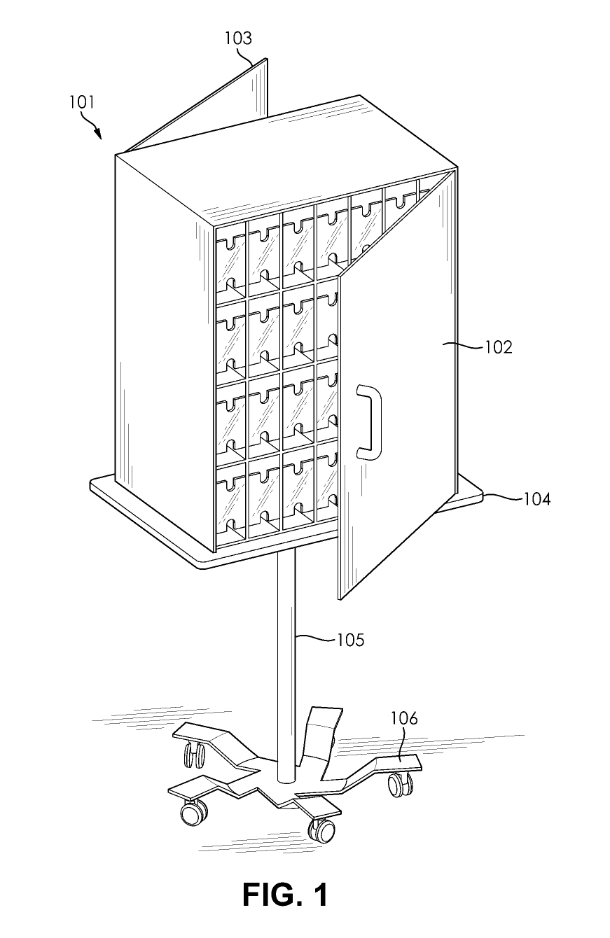

Referring in detail to the drawings, the device of the present invention is illustrated in FIG. 1 for carrying and dispensing medical items, the device being indicated by the general reference number 101.

Device 101 generally comprises an optional front, hinged door 102, in this example hinged on the right most side, as well as optional hinged rear door 103, in this example hinged on the left. Hinged front door 102 and rear door 103 provide additional protection from air currents or airborne fluids or particulates, as well as protecting the contents during transport. Hinged rear door 103 may allow access to the removable rear planar face contemplated by one embodiment of the present invention, or in the alternative, should the rear planar face be entirely absent, the hinged rear door 103 may represent said removable rear planar face.

A shown in FIG. 1, device 101 rests on a horizontal planar support 104, and may be fixed to the horizontal planar support 104, or free floating. In the demonstrated embodiment of the present, device 101 is supported above castor wheeled mount 106 by a vertical support element 105, said castor wheeled mount 106 providing ease of movement and transport of said device 101.

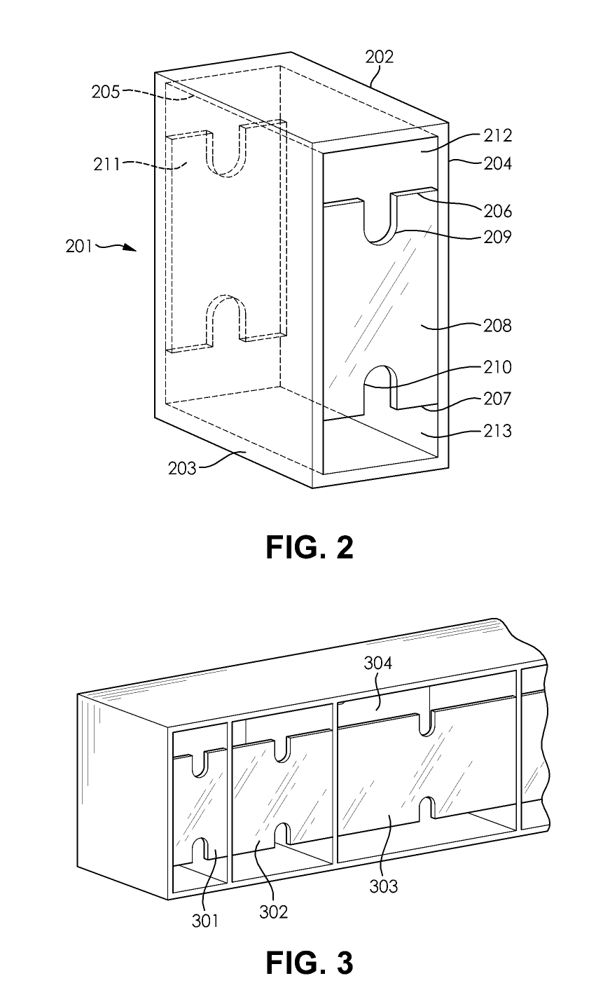

FIG. 2 shows a side elevation cutaway of compartment 201 that forms part of the device of the present invention. Each compartment is described by an upper planar surface 202, lower planar surface 203, right lateral surface 204 and left lateral surface 205. As there are a multiplicity of compartments forming the device of the present invention, the upper planar surface 202 also may represent a lower planar surface of an adjacent compartment above; similarly surfaces 203, 204 and 205 would represent opposing surfaces of adjacent compartments. The facing planar surface 208 is described by an upper edge 206 and lower edge 207, each offset from upper planar surface 202 and lower planar surface 203 respectively. In one aspect of the present invention, depicted in FIG. 2, semi-circular depressions 209 and 210 are present in upper edge 206 and lower edge 207 respectively. The presence of the semi-circular depressions serve to allow access of the digits of the users selecting medical items from the interior of the compartment; and as such are sized in a preferred embodiment of 10-15 mm in radius, and in a still preferred embodiment at least 15 mm in radius.

As shown in FIG. 2, upper edge 206 and lower edge 207 of facing planar surface 208 are offset from the upper planar surface 202 and lower planar surface 203, respectively. This then provides for an upper facing surface space 212 and lower facing surface space 213. The specific horizontal size of the upper facing surface space 212 and lower facing surface space 213 is dependent upon the horizontal height of medical articles planned on being dispensed from compartment 201, with a height of at least 150% of the height of the article being dispensed recommended, or at least 27 mm. Medical items may be loaded into the compartment through upper facing space, lower facing space, or through the optional removable rear surface or hinged door described herein. In a preferred embodiment, medical articles are removed through the lower facing surface space 213, with addition of new medical items provided from the upper facing surface space 212 or from the rear when the rear planar surface is either absent, removable, or with at least an upper rear surface space as described herein.

FIG. 2 depicts one embodiment of the present invention with rear planar surface 211 which mirrors the facing planar surface 208, rather than being a contiguous planar surface, a removable planar surface, or a hinged door.

FIG. 3 shows an example of a multiplicity of adjacent compartments, compartment 301, 302 and 303, with variable widths, for storage and dispensing of different sized medical items in accordance with the present invention. In the presented example, rear planar surface 304 is contiguous and non-removable.

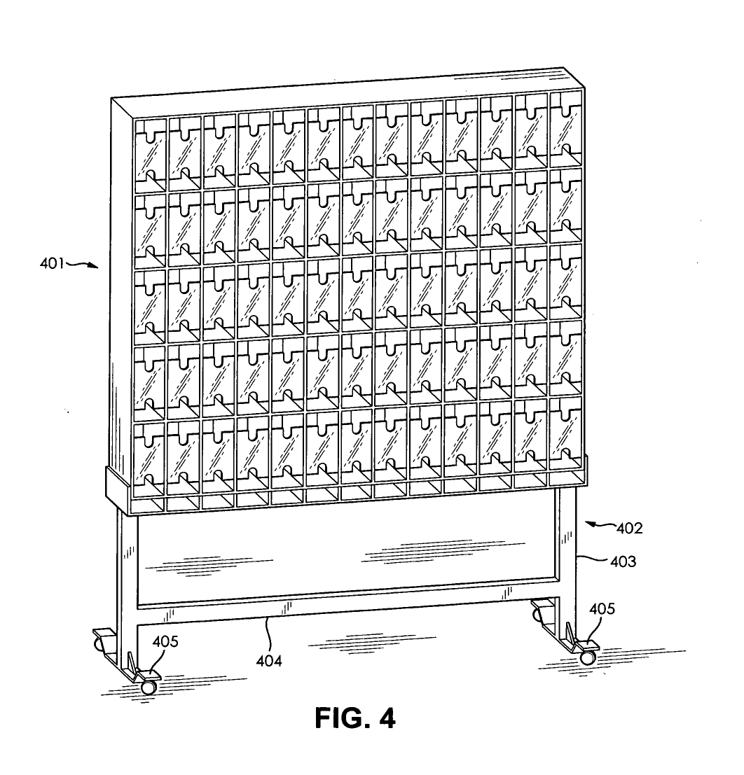

FIG. 4 shows one embodiment of the device of the present invention 401, comprising a multiplicity of compartments, residing on support 402, itself comprising vertical support members 403, horizontal support member 404, with wheels 405 forming part of vertical support members 403.

The device of the present invention provides for easy and quick access to the serially organized medical items, and optionally classified according to compartment, for use in a clinical or medical setting. The inclusion of the optional front and rear hinged doors protects the contents and individual compartments forming the device of the present invention. The device of the present invention provides an efficient and easy means of providing, and controlling, access to stock of medical items in locations relevant for the users. It further facilitates access to the persons in need of, or tasked with providing the physicians or medical personnel with, medical items needed in the course of medical procedures such as in treatment rooms, operating theatres, triage facilities, or other locations known in the art.

While particular embodiments of the present invention have been described in the foregoing, it is to be understood that other embodiments are possible within the scope of the invention and are intended to be included herein. It will be clear to any person skilled in the art that modification of and adjustments to this invention, not shown, are possible without departing from the spirit of the invention as demonstrated through the exemplary embodiments. The invention is therefore to be considered limited solely by the scope of the appended claims.

What is claimed is:

1. A device for carrying medical items, wherein the device comprises:
a multiplicity of hollow compartments
each compartment being a hollow cuboid described by an upper and lower planar surface, a left lateral surface, a right lateral surface, a rear planar surface and a facing planar surface;
wherein said upper planar surface, lower planar surface, left lateral planar surface, right lateral planar surface and rear planar surface are contiguous;
wherein said facing planar surface comprises:
an upper edge offset and lower edge offset from the upper planar surface and lower planar surface, thereby providing an upper facing surface space and a lower facing surface space,
a right lateral edge and a left lateral edge substantially contiguous with the facing edge of said left lateral planar surface and right lateral planar surfaces; and
wherein said upper edge offset and lower edge offset are offset from said upper planar surface and lower planar surfaces by a distance of at least 27 mm.

2. The device of claim 1 wherein said rear planar surface is removable, providing access to the hollow interior described by the upper planar surface, lower planar surface, right lateral planar surface, left lateral planar surface and facing planar surface.

3. The device of claim 1 wherein said upper edge of said facing planar surface contains a semi-circular depression of radius at least 15 mm.

4. The device of claim 1 wherein said lower edge of said facing planar surface contains a semi-circular depression of radius at least 15 mm.

5. The device of claim 1 wherein said lower edge and upper edge of said facing planar surface contain a semi-circular depression of at least 15 mm.

6. A device for carrying medical items, wherein the device comprises:
a multiplicity of hollow compartments
each compartment being a hollow cuboid described by an upper planar surface, a lower planar surface, a left lateral planar surface, a right lateral planar surface, a rear planar surface, and a facing planar surface
wherein said upper planar surface, lower planar surface, left lateral planar surface, right lateral planar surface and rear planar surface are contiguous,
wherein said facing planar surface comprises
an upper edge offset and lower edge offset from the upper planar surface and lower planar surface, thereby providing an upper facing surface space and a lower facing surface space, and
a right lateral edge and a left lateral edge substantially contiguous with the facing edge of said left lateral planar surface and right lateral planar surfaces,
wherein said upper edge offset and lower edge offset are offset from said upper planar surface and lower planar surface a by a distance of at least 27 mm;
wherein said rear planar surface comprises
an upper edge and lower edge offset from the upper planar surface and lower planar surface, thereby providing an upper rear surface space and a lower rear surface space, and
a right lateral edge and a left lateral edge substantially contiguous with the rear edge of said left lateral planar surface and right lateral planar surface; and
wherein said upper edge offset and lower edge offset are offset from said upper planar surface and lower planar surfaces by a distance of at least 27 mm.

7. The device of claim 6 wherein said facing planar surface and upper edge of said rear planar surface contains a semi-circular depression of radius at least 15 mm.

8. The device of claim 6 wherein said facing planar surface and lower edge of said rear planar surface contains a semi-circular depression of radius at least 15 mm.

9. The device of claim 6 wherein said lower edge and upper edge of said facing planar surface and upper edge and lower edge of said rear planar surface contain a semi-circular depression of at least 15 mm.

10. A device for carrying medical items, wherein the device comprises:
A multiplicity of hollow compartments
each compartment being a hollow cuboid described by an upper and lower planar surface, a left lateral surface, a right lateral surface, and a facing planar surface;
wherein said upper planar surface, lower planar surface, left lateral planar surface, and right lateral planar surface are contiguous;
wherein said facing planar surface comprises:
an upper edge offset and lower edge offset from the upper planar surface and lower planar surface, thereby providing an upper facing surface space and a lower facing surface space,
a right lateral edge and a left lateral edge substantially contiguous with the facing edge of said left lateral planar surface and right lateral planar surfaces; and
wherein said upper edge offset and lower edge offset are offset from said upper planar surface and lower planar surfaces by a distance of at least 27 mm.

11. The device of claim 10 wherein said upper edge of said facing planar surface contains a semi-circular depression of radius at least 15 mm.

12. The device of claim 10 wherein said lower edge of said facing planar surface contains a semi-circular depression of radius at least 15 mm.

13. The device of claim 10 wherein said lower edge and upper edge of said facing planar surface contain a semi-circular depression of at least 15 mm.
